(19) United States
(12) Patent Application Publication
(10) Pub. No.: US 2018/0135634 A1
(43) Pub. Date: May 17, 2018

(54) Fan with Connector Powered by Mobile Device

(71) Applicant: Jeff Leitman, Irvine, CA (US)

(72) Inventor: Jeff Leitman, Irvine, CA (US)

(21) Appl. No.: 15/868,935

(22) Filed: Jan. 11, 2018

Related U.S. Application Data
(63) Continuation-in-part of application No. 15/406,633, filed on Jan. 13, 2017.
(60) Provisional application No. 62/614,200, filed on Jan. 5, 2018.
(60) Provisional application No. 62/278,421, filed on Jan. 13, 2016.
(60) Provisional application No. 62/336,562, filed on May 13, 2016.

(51) Int. Cl. F04D 25/08; F04D 25/06; F04D 19/00; F04D 29/054; G06F 1/16; H04M 1/21; H04B 1/3827

(52) U.S. Cl. CPC F04D 25/084; F04D 25/0673; F04D 19/002; H04B 1/3833; G06F 1/1656; H04M 1/21; F04D 29/054

(57) ABSTRACT

A fan powered by a mobile device is provided comprising an L-shaped body, a motor within the body, fan propeller blades attached one end of the L-shaped body, and a connector protruding from the other end of the L-shaped body that is capable of being inserted into a mobile device port in order to draw power from the mobile device. The L shaped body is bent at an angle between 45 and 135 degrees and or can be bent at a 90 degree right angle. The connector includes a front, two sides, top and bottom where the front includes four flat leading surfaces, each leading to the two sides, top and bottom such that the connector increases in height and width as it is inserted into a receptacle until the maximum height and width of the connector is reached and two indentations, one on each side, where the indentations include flat receding surfaces for holding the connector in place at a correct depth of insertion to make contact with the contacts of the receptacle.

### CROSS REFERENCE TO RELATED APPLICATIONS

This application claims priority from nonprovisional U.S. patent application Ser. No. 15/406,663 filed on Jan. 5, 2018. This application claims priority from provisional U.S. patent application Ser. No. 15/406,663 filed on Jan. 13, 2017. U.S. patent application Ser. No. 15/406,663 is a non-provisional application claiming priority provisional U.S. patent application No. 62/278,421 filed on Jan. 13, 2016 and provisional U.S. patent application No. 62/336,562 filed on May 13, 2016.

### FIELD OF THE INVENTION

Embodiments of the invention generally relate to portable fans. Embodiments of the invention specifically relate to a portable fan powered by a mobile device

### BACKGROUND OF THE INVENTION

Mobile devices, such as cellular and/or smartphones, have grown considerably in popularity. Various accessories and attachments can be plugged into and powered by phones, such as credit card readers and cameras. Most mobile devices have a port used for charging the device and transmitting data. Additionally, these ports can be used to provide power from the mobile device to an accessory attachment. While micro USB is a standard port, accessories may require other connectors that are compatible with the specific connector port on the owner's mobile device.

Handheld portable fans can be carried by a user for individual cooling. Portable fans are generally powered by batteries. However, a mobile device through its charging port is sufficient to power a fan.

### SUMMARY

A fan powered by a mobile device is provided. This invention provides for a fan to be powered by a mobile device, such as cellular and/or smart phones, which most individuals carry around. Once plugged into the mobile device, the mobile device outputs a current to power the fan through the device's charging port by connecting the fan via the appropriate device connector.

A fan powered by a mobile device is provided comprising an L-shaped body, a motor within the body, fan propeller blades attached one end of the L-shaped body, and a connector protruding from the other end of the L-shaped body that is capable of being inserted into a mobile device port in order to draw power from the mobile device. The connector includes a front, two sides, top and bottom where the front includes four flat leading surfaces, each leading to the two sides, top and bottom such that the connector increases in height and width as it is inserted into a receptacle until the maximum height and width of the connector is reached and two indentations, one on each side, where the indentations include flat receding surfaces for holding the connector in place at a correct depth of insertion to make contact with the contacts of the receptacle. The connector further includes contacts on the top surface of the connector and can additionally include two ground contacts on the top surface at the corners near the front of the connector. The L shaped body is bent at an angle between 45 and 135 degrees and or can be bent at a 90 degree right angle.

An alternative fan powered by a mobile device is provided comprising a first piece of a fan body, a second piece of a fan body such that the two pieces of the fan body are connected via a hinge, a motor within the first fan body piece; fan propeller blades attached to the first fan body piece and a connector protruding from the second fan body piece that is capable of being inserted into a mobile device port in order to draw power from the mobile device. The connector includes a front, two sides, top and bottom where the front includes four flat leading surfaces, each leading to the two sides, top and bottom such that the connector increases in height and width as it is inserted into a receptacle until the maximum height and width of the connector is reached and two indentations, one on each side, where the indentations include flat receding surfaces for holding the connector in place at a correct depth of insertion to make contact with the contacts/pins of the receptacle.

### BRIEF DESCRIPTION OF THE DRAWINGS

FIG. 1A is a front view of a fan embodiment.

FIG. 1B is a rear view of a fan embodiment.

FIG. 1C is a top view of a fan embodiment.

FIG. 1D is a bottom view of a fan embodiment.

FIG. 1E is a side view of a fan embodiment.

FIG. 2 is a diagram of a basic motor.

FIG. 3 is a diagram of a mobile device with an attached fan embodiment

FIG. 4A is a top view of a connector embodiment.

FIG. 4B is a bottom view of a connector embodiment.

FIG. 4C is a side view of a connector embodiment.

FIG. 4D is a front view of a connector embodiment.

FIG. 5A is a front view of a fan embodiment.

FIG. 5B is a rear view of a fan embodiment.

FIG. 5C is a top view of a fan embodiment.

FIG. 5D is a bottom view of a fan embodiment.

FIG. 5E is a side view of a fan embodiment.

FIG. 6 is a diagram of a mobile device with an attached fan embodiment

### DETAILED DESCRIPTION

Reference will now be made in detail to the present embodiments discussed herein, illustrated in the accompanying drawings. The embodiments are described below to explain the disclosed invention by referring to the Figures using like numerals. It will be nevertheless be understood that no limitation of the scope is thereby intended, such alterations and further modifications in the illustrated device, and such further applications of the principles as illustrated therein being contemplated as would normally occur to one skilled in the art to which the embodiments relate. Those skilled in the art will recognize that other implementations may be performed that may include different structures or components that perform similar tasks.

A fan powered by a mobile device is provided. Mobile devices include, but are not limited to, cellular phones, smartphones, tablets, PDAs, and laptops.

While other handheld fans require batteries for operation, this invention provides for a fan to be powered by a mobile device, such as cellular and/or smart phones, which most individuals carry around. Once plugged into the mobile device, the mobile device outputs a current to power the fan. This is done through the device's charging port by connecting the fan via the appropriate device connector. The fan has an L shaped body that projects the cooling breeze in the direction of the user.

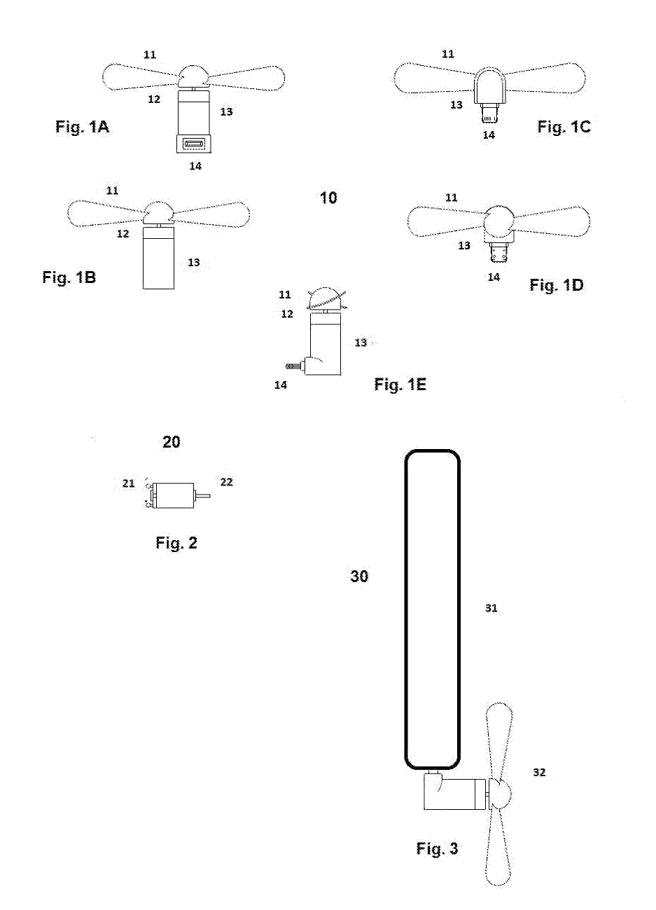

As illustrated in FIGS. 1A, 1B, 1C, 1D, 1E, a diagram of a fan embodiment 10 is provided. The fan comprises a propeller 11, small motor 12, L shaped body 13 and a mobile device connector 14.

Visible in FIGS. 1A-1E, the fan propeller 11 spins at a high rate of speed, pushing air at the user to provide a cooling breeze. The present embodiment depicts two blades, each one inch in size. Other embodiments may vary the number and size of the propeller blades. The propeller is connected to a motor 12, partially visible in FIGS. 1A, 1B and 1C, specifically the rotor shaft/axel. The motor 12 causes the fan propeller 11 to spin. Motor size and power may vary as long as the motor is able to spin the propeller at a sufficient speed. Most of the motor 12 is contained within one end of the solid, single piece, L shaped body 13 of the fan. The fan body must be large enough to contain the motor. The L shaped body bends at 90 degrees, though other alternative embodiments with angles between 45 and 135 degrees may accomplish the similar task of directing the fan at the user. The connector 14 protrudes from the other end of L shaped body 13, as depicted in FIGS. 1A, 1C, 1D, and 1E.

As illustrated in FIG. 2, a diagram of a motor 20 is provided. The motor causes the rotor shaft/axel 21 to spin. The rotor shaft/axel protrudes from the L shaped fan body and is attached to the fan propeller. The rest of the motor is located within the fan body 13. Power is provided to the motor via the +/− terminals 22. The motor is configured to be able to run on the volts provided by the connector.

As illustrated in FIG. 3, a diagram of a mobile device with an attached fan embodiment 30 is provided. The fan 32 is connected to the mobile device 31 via the connector. Upon insertion of the connector into the port on the mobile device 31, power is transmitted from the mobile device to power the motor and spin the fan propeller. As depicted in the present embodiment, the L shaped body causes the fan 32 to point 90 degrees from the port and in the direction of the mobile device user to provide optimal cooling. In other embodiments, the degree of the bend in the L shaped body can vary between the range of 45 degrees and 135 degrees. Additionally, when plugged into a device, the L shaped body shifts the fan downward such that the blades do not obscure the user's view or prevent the user from being able to operate the device. Other embodiments may shift the blades even further downward to provide greater access to the device screen/interface, by elongating the portion of the L shaped body with the connector.

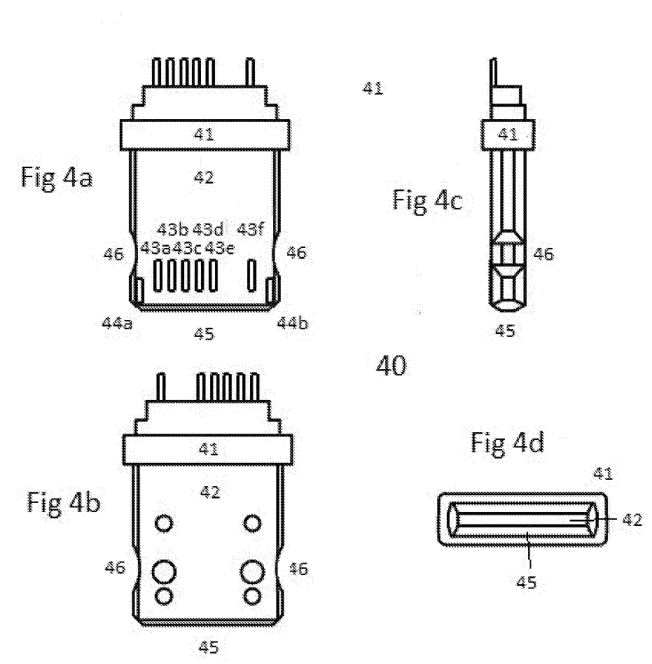

As illustrated in FIGS. 4A, 4B, 4C, and 4D, a connector embodiment 40 is provided. This figures show the top, bottom, side and front surfaces respectively. The connector 40 includes a body 41, where a user would typically hold the connector, and a flat tab portion 42 extending from the body, such that the tab portion is inserted into the mobile device port/receptacle. The tab is inserted in such a way that upon insertion of the tab into the mobile device, the pins/contacts 43a, 43b, 43c, 43d, 43e, 43f (collectively 43) on the plug contact the pins/contacts on the receptacle. Visible in the top view FIG. 4A, a plurality of primary contacts 13 are located on the top side of the tab portion of the connector, the contacts running parallel to each other. Additionally two ground contacts 44a, 44b are located on the top side of the tab portion on the corners of the distal end (first inserted into the receptacle) of the tab.

The contacts 43 are manufactured 1 U″ of gilding on copper and two ground contacts that are 100U″ of nickel on copper, though other embodiments may use one or more difference conductive materials. The contacts 43 are positioned such that plastic is injected into a molding to form the connector tab.

The molding creates hexagonal angle edges 45 on the distal end (first inserted into the receptacle) of the connector tab, especially visible in the side view FIG. 4C and the front view FIG. 4D. The four edges/leading surfaces 45 extend from the distal end to both sides, top and bottom of the connector tab, such that these flat leading surfaces increase the width and height of the connector comparative to the front portion/distal end of the connector. The angled edges x make it so that the tip of the tab is smaller than the receptacle and allows for the tab to me more easily inserted into the receptacle. As the connector is further inserted, the tab increases in width and height and fits snuggly into receptacle. Additionally, the tab portion of the connector includes, on each side of the tab, angular/hexagonal indentations 46, having flat receding surfaces, especially visible in the top view FIG. 4A, the bottom view FIG. 4B and the side view FIG. 4C. These indentations 46 or notches are used to click-in and hold the connector in place when it is inserted to the correct depth to make contact with the contacts/pins of the receptacle.

The connector has contacts 43 on a single face of the connector, such that the connector is inserted in a single orientation. In the present embodiment, the connector tab includes six primary contacts 43a, 43b, 43c, 43d, 43e, 43f and two ground contacts. The first 5 contacts 43a, 43b, 43c, 43d, 43e are spaced equidistant from each other with a larger area of separation between the fifth 43e and sixth contacts 43f. The primary contacts are respectively: D+ 43a; D− 43b; datas 43c; datas 43d; testing 43c; empty pin 43f. However, the fourth 43d and fifth 43d pins/contacts, can be configured to be used on a small accessory device to draw power from a mobile device. Thus because data transfer is not necessary, less pins are needed that other similar connectors. The power received through the connector 40 from the mobile device is outputted through terminals. The connector has a specific shape such that it must be inserted in such a way that the pins on the plug contact the pins on the receptacle.

In an alternative fan embodiment, instead of a single L shaped body structure, there are 2 separate fan body pieces that are connected by a hinge. The hinge allows for the fan to bend and change direction without having to remove and reinsert the fan via a reversible connector

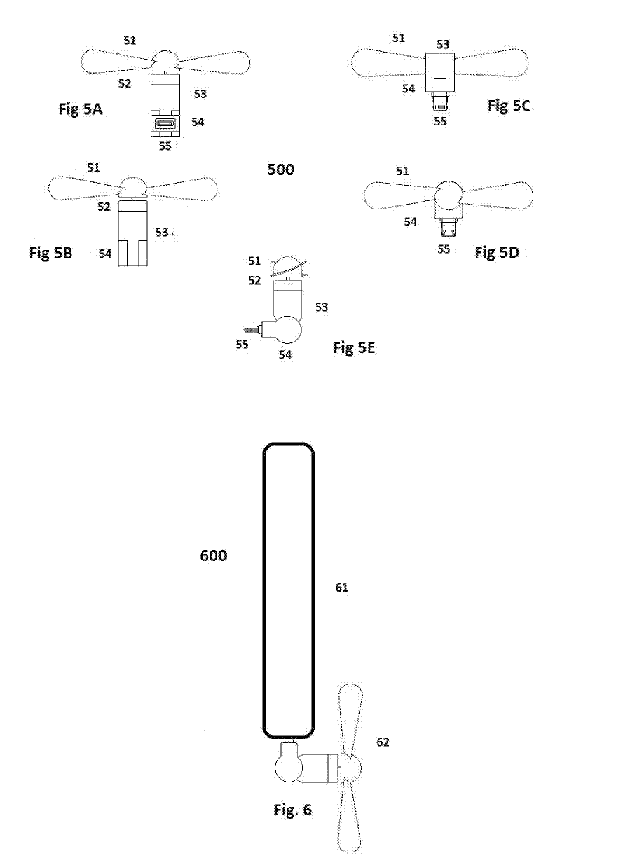

As illustrated in FIGS. 5A, 5B, 5C, 5D, 5E, a diagram of a fan embodiment 500 is provided. The fan comprises a propeller 505, small motor 510, a first body piece 515 connected via a hinge to a second body piece 520 and a mobile device connector 525. The hinge gives the fan the reversible functionality without the need to unplug and reinsert the fan.

Visible in FIGS. 5A, 5B, 5C, 5D, 5E, the fan propeller 505 spins at a high rate of speed, pushing air at the user to provide a cooling breeze. The present embodiment depicts two blades, each one inch in size. Other embodiments may vary the number and size of the propeller blades. The propeller is connected to a motor 510, partially visible in FIGS. 5A, 5B and 5C, specifically the rotor shaft/axel. The motor 510 causes the fan propeller 505 to spin. Motor size and power may vary as long as the motor is able to spin the propeller at a sufficient speed. Most of the motor 510 is contained within one end of the piece of the body 515 of the fan. The fan body must be large enough to contain the motor. The first body piece 515 is connected via a hinge to a second body piece 520. The connector 525 protrudes from the other end of second body piece 520, as depicted in FIGS. 5A, 5C, 5D, and 5E.

Such a fan embodiment includes a motor 20 that causes the rotor shaft/axel 22 to spin. The rotor shaft/axel protrudes from the first piece of the fan body and is attached to the fan propeller. The rest of the motor is located within the first piece of body 53. Power is provided to the motor via the +/− terminals 21. The motor is configured to be able to run on the volts provided by connector.

Such a fan embodiment includes a connector protruding from the second piece of the body 30. The connector 30 is plugged into a specific port/receptacle found on some mobile devices. The power received through the connector 30 from the mobile device is outputted to the motor 20 within the first body piece of the fan. One skilled in the art should recognize that the connection can be made directly or through an intermediary such as a wire or other means.

As illustrated in FIG. 6, a diagram of a mobile device with an attached fan embodiment 600 is provided. The fan 62 is connected to the mobile device 61 via the connector. Upon insertion of the connector into the port on the mobile device 61, power is transmitted from the mobile device to power the motor and spin the fan propeller. As depicted in the present embodiment, the hinge between the first and second pieces of the fan body allows the fan 62 to point 90 degrees from the connector port and in the direction of the mobile device user to provide optimal cooling. The hinge allows the user to rotate the fan to point it away from himself/herself and instead at others. The hinge provides a means to lock the fan at the two opposing 90 degree right angle positions. This can be done by creating indentations that allow the fan to “click in” to place and maintain a position. Some embodiments allow for multiple configurations at the hinge such that the hinge can lock into place at degree intervals, common intervals including but not limited to 45 and 30 degrees. Additionally, when plugged into a device, the second piece of the fan body (with the protruding connector plug) shifts the fan downward such that the blades do not obscure the user's view or prevent the user from being able to operate the device. Other embodiments may shift the blades even further downward to provide greater access to the device screen/interface, by elongating this second piece of the fan body.

The preceding description contains embodiments of the invention and no limitation of the scope is thereby intended.

That which is claimed is:

1. A fan powered by a mobile device comprising:
An L-shaped body;
A motor within the body;
Fan propeller blades attached one end of the L-shaped body;
A connector protruding from the other end of the L-shaped body that is capable of being inserted into a mobile device port in order to draw power from the mobile device, the connector comprising:
a) a front, two sides, top and bottom surface where the front includes four flat leading surfaces, each leading to the two sides, top and bottom such that the connector increases in height and width as it is inserted into a receptacle until the maximum height and width of the connector is reached;
b) two indentations, one on each side, where the indentations include flat receding surfaces for holding the connector in place at a correct depth of insertion to make contact with contacts of a receptacle.

2. The fan of claim 1, wherein the L shaped body is bent at an angle between 45 and 135 degrees.

3. The fan of claim 2, wherein the L shaped body is bent at a 90 degree right angle.

4. The fan of claim 1, where in the connector further comprises:
A plurality of contacts on the top surface.

5. The fan of claim 1, where in the connector further comprises:
Two ground contacts on the top surface at the corners near the front of the connector.

6. A fan powered by a mobile device comprising:
A first piece of a fan body;
A second piece of a fan body;
Such that the two pieces of the fan body are connected via a hinge;
A motor within the first fan body piece;
Fan propeller blades attached to the first fan body piece;
A connector protruding from the second fan body piece that is capable of being inserted into a mobile device port in order to draw power from the mobile device, the connector comprising:
a) a front, two sides, top and bottom where the front includes four flat leading surfaces, each leading to the two sides, top and bottom such that the connector increases in height and width as it is inserted into a receptacle until the maximum height and width of the connector is reached;
b) two indentations, one on each side, where the indentations include flat receding surfaces for holding the connector in place at a correct depth of insertion to make contact with the contacts of the receptacle.

7. The fan of claim 6 further comprising a means for locking the hinge in position to form opposing 90 degree right angles.

8. The fan of claim 7 further comprising a means for locking the hinge in position at degree intervals.

9. The fan of claim 1, where in the connector further comprises:
A plurality of contacts on the top surface.

10. The fan of claim 1, where in the connector further comprises:
Two ground contacts on the top surface at the corners near the front of the connector.
